(19) United States
(12) Patent Application Publication
(10) Pub. No.: US 2005/0213052 A1
(43) Pub. Date: Sep. 29, 2005

(54) Structure of liquid crystal cells and projection lenses and image projection system using the same

(75) Inventors: David L. Keith, Vancouver, WA (US); Chris Brandt, Portland, OR (US); Jin-yong Park, Seoul (KR); Sung-ho Kim, Suwon-si (KR); Jun-su Kim, Pyeongtaek-si (KR)

Correspondence Address: KLARQUIST SPARKMAN, LLP, 121 SW SALMON STREET, SUITE 1600, PORTLAND, OR, 97204, US

(73) Assignee: ILJIN Diamond Co., Ltd.

(21) Appl. No.: 11/021,519

(22) Filed: Dec. 23, 2004

Related U.S. Application Data
(63) Continuation-in-part of application No. 10/794,806, filed on Mar. 5, 2004, now abandoned.
(60) Provisional application No. 60/452,885, filed on Mar. 7, 2003.

(51) Int. Cl. G03B 21/00

(52) U.S. Cl. 353/94; 353/31

(57) ABSTRACT

The present invention generally relates to a structure of liquid crystal cells and projection lenses and an image projection system using the same, and more specifically, to a structure of liquid crystal cells which rotates and is easily movable in a predetermined axial direction and projection lenses for an LCD projector easily movable in a predetermined axial direction and an image projection system using the same. The structure of the liquid crystal cells and the projection lenses in accordance with the present invention and the image projection system using the same can easily control the liquid crystal cells and the projection lenses in order to exactly adjust focuses thereof.

### BRIEF DESCRIPTION OF THE DRAWINGS

The invention, together with further aspects and advantages thereof, may best be understood by reference to the following description taken in conjunction with the accompanying drawings in which:

FIG. 1 is a format diagram of an image projection system using a prior 3-liquid crystal 3-projection lens;

FIG. 2 is a sectional view illustrating a structure of liquid crystal cells and projection lenses in accordance with the present invention;

FIG. 3 is a front view illustrating a structure of liquid crystal cells and projection lenses in accordance with the present invention; and

FIG. 4 is a perspective view illustrating a structure of projection lenses in accordance with the present invention.

FIG. 5 shows the holder for liquid crystal cell according to the embodiment of the present invention.

FIG. 6 shows the holder with the liquid crystal cell on according to the embodiment of the present invention.

FIG. 7 illustrates the alignment of the liquid crystal on the carrier according to the embodiment of the present invention.

FIG. 8 is a perspective view showing the alignment of the liquid crystal on the carrier according to the embodiment of the present invention.

FIG. 9 shows construction of the composite image projection system which uses one compound lens and two projection lenses as another embodiment of the present invention.

### DESCRIPTIONS OF NUMBERS ABOUT MAIN PARTS OF THE DRAWINGS

20: carrier 20a, 20b, 20c, 20d: alignment pin
22: rail 30a, 30b, 30c: liquid crystal cells 32: substrate
34: analyzer 36a, 36b, 36c: projection lens
100: structure of liquid crystal cells and projection lenses
110: holder 110a, 110b, 110c, 110d: alignment hole
111: flexible cable

### DETAILED DESCRIPTION OF THE INVENTION

### PURPOSE OF THE INVENTION

### BACKGROUND OF THE INVENTION

The present invention generally relates to a structure of liquid crystal cells and projection lenses and an image projection system using the same, and more specifically, to a structure of liquid crystal cells which rotates and is easily movable in a predetermined axial direction and projection lenses for an LCD projector easily movable in a predetermined axial direction and an image projection system using the same.

A projection system using a liquid crystal is a device for supplying image information through the liquid crystal for selectively turning on/off light separated into each color, after separating the light emitted from a light source into R, G, and B colors through dichroic mirrors. In prior art, a projection system using a CRT(Cathode Ray Tube), instead of the liquid crystal, has been mainly used, but the projection system using the CRT is large in size. Thus, the projection system using the liquid crystal has been replaced.

The projection system using the liquid crystal has two kinds: (1) a liquid crystal projection system (hereinafter denoted as ‘three-plate liquid crystal projection system’) which is separating a light source into R, G, and B colors, generating images by color, synthesizing the R, G, and B colors by using one synthetic lens, and projecting a synthesized image on a screen by using on projection lens; and (2) the other liquid crystal projection system (hereinafter denoted as ‘three-plate liquid crystal projection system’) which is separating a light source into R, G, and B colors, generating images by color, and projecting the images on a screen by use of three projection lenses, thereby according focuses thereof.

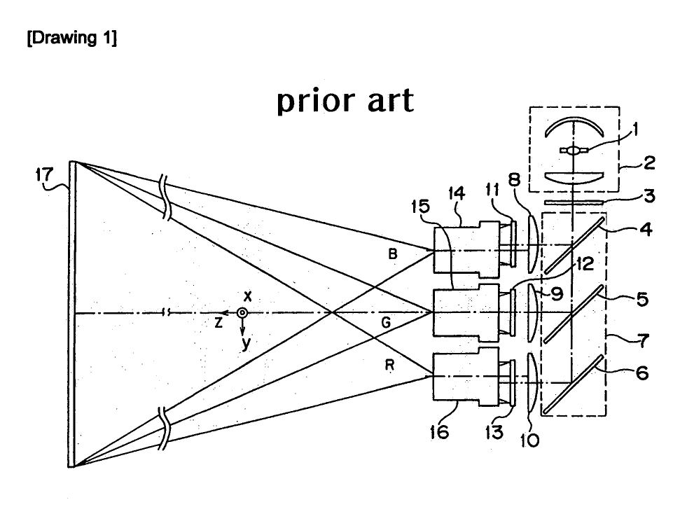

The present invention is applied to the latter three plate liquid crystal projection system, and a representative example of the three plate liquid crystal projection system in accordance with prior art is described in FIG. 1.

Light emitted from a lighting equipment(2) having at least one light source(1) is incident on a system(7) of R, G, and B dichroic mirrors(4,5,6) through a UV blocking lens(3). Each of the dichroic mirrors(4,5,6) reflects rays only of a corresponding wavelength band, and transmits the rest rays. For instance, the R dichroic mirror(4) reflects rays only of an R wavelength band, and transmits rays of the rest wavelength bands. Rays reflected by each of the dichroic mirrors(4,5,6) are incident on each liquid cell(11,12,13) through field lenses(8,9,10). Each image of R, G, and B colors is formed by on/off operations of the liquid crystal cells(11,12,13), and the formed images of the R, G, and B colors are projected on a screen(1 ).

Like shown in FIG. 1, the R, G, and B colors arrive on a center of the screen(17) from each projection lens(14,15,16) at different intervals, respectively. So, like shown in the diagram, the G liquid crystal cell(12) and the projection lens(15) are disposed on the same line. On the other hand, though being not described in the diagram, both the R liquid crystal cell(13) and the R projection lens(16) and both the B liquid crystal cell(11) and the B projection lens(14) are disposed, being separated from the same line a little, thereby enabling light to be incident on a central point of the screen(17). Also, a range of light emitted from the R, G, and B projection lenses changes toward both edges of the screen(17) from each projection lens(14,15,16). Thus, in case of a 3-liquid crystal 3-projection lens system shown in FIG. 1, it is necessary to have a structure of liquid crystal cells and projection lenses capable of easily controlling each projection lens or each liquid crystal cell in order to exactly adjust focuses thereof.

### SUMMARY OF THE INVENTION

It is therefore an object of the present invention to provide a structure of liquid crystal cells and projection lenses for easily controlling the projection lenses and the liquid crystal cells and an image projection system using the same.

### DETAILED DESCRIPTION OF THE PREFERRED EMBODIMENTS

To accomplish the above object, a structure of liquid crystal cells and projection lenses in accordance with the present invention movable in a predetermined axial direction with rotations, comprising: a carrier having an upper frame and a lower frame configured in bar shape; R, G, and B liquid crystal cells disposed between the upper frame and the lower frame of the carrier; analyzers installed for the R, G, and B liquid crystal cells, respectively, and disposed on back sides of each liquid crystal cell at certain intervals; projection lenses installed for the R, G, and B liquid crystal cells, respectively, disposed on back sides of each analyzer at certain intervals for an incident direction of light, and tied to at least either the upper frame or the lower frame of the carrier; and a rail formed in horizontal direction on a side where the projection lenses are tied to either the upper frame or the lower frame of the carrier. Each liquid crystal cell comprises: at least two tightening members compressing one side of either an upper side or a lower side of each liquid crystal cell by being tied and tightened in a piercing groove formed on one of either the upper frame or the lower frame of the carrier; and at least two elastic members mounted between the other side of either the upper side and the lower side of each liquid crystal cell and the other one of either the upper frame or the lower frame of the carrier, and supporting the rest sides of each liquid crystal cell.

It is desirable to dispose each tightening member and each elastic member on the same extension in vertical direction. Furthermore, the structure of the liquid crystal cells and the projection lenses further includes substrates attached to one side of each analyzer, opposite to the incident direction of light. At this time, it is desirable to use sapphire substrates.

In addition, to achieve the other object, a structure of projection lenses in accordance with the present invention moves each projection lens in a predetermined axial direction for R, G, and B projection lenses on which light selectively turned on/off by liquid crystal cells is incident by being separated into R, G, and B colors, comprising: frames having piercing grooves pierced on both sides; more than one shaft mounted on upper and lower sides of the frames; supporting plates installed for the R, G, and B projection lenses, respectively, and having inserting grooves pierced on the left and the right to insert the shafts into upper ends and lower ends; the R, G, and B projection lenses mounted on back sides of each supporting plate for an incident direction of light; many elastic members inserted into the shafts, disposed between inserting grooves of neighboring supporting plates among the supporting plates, and supporting each supporting plate; and more than one fine adjuster inserted/tied to each piercing groove of the frames, and compressing sides of the supporting plates.

It is desirable that each supporting plate further includes many piercing grooves pierced on front and rear sides to insert fixing members for fixing each supporting plate into the frames.

In addition, to achieve the other object, another embodiment of a structure of projection lenses in accordance with the present invention comprises: a carrier, the carrier having at least one frame of an upper frame and a lower frame, the upper frame and the lower frame configured in bar shape; the R, G, and B projection lenses, the R, Q and B projection lenses respectively disposed on back sides of each liquid crystal cells for an incident direction of light, and the R, G, and B projection lens tied to at least one frame of the carrier; and a rail, the rail formed in horizontal direction on a side where the R, G, and B projection lenses are tied to the frame of the carrier.

Moreover, to accomplish the other object, an image projection system using a structure of liquid crystal cells and projection lenses in accordance with the present invention uses at least one light source, dichroic mirrors separating light emitted from the light source into R, G, and B colors, the liquid crystal cells selectively turning on/off light outputted from the dichroic mirrors and movable in a predetermined axial direction with rotations, and the structure of the liquid crystal cells and the projection lenses. The structure of the liquid crystal cells and the projection lenses comprises: a carrier having an upper frame and a lower frame configured in bar shape; R, G, and B liquid crystal cells disposed between the upper frame and the lower frame of the carrier; analyzers installed for the R, G, and B liquid crystal cells, respectively, and disposed on back sides of each liquid crystal cell at certain intervals; projection lenses installed for the R, G, and B liquid crystal cells, respectively, disposed on back sides of each analyzer at certain intervals for an incident direction of light, and tied to at least either the upper frame or the lower frame of the carrier; and a rail formed in horizontal direction on a side where the projection lenses are tied to either the upper frame or the lower frame of the carrier. Each liquid crystal cell comprises: at least two tightening members compressing one side of either an upper side or a lower side of each liquid crystal cell by being tied and tightened in a piercing groove formed on one of either the upper frame or the lower frame of the carrier; and at least two elastic members mounted between the other side of either the upper side and the lower side of each liquid crystal cell and the other one of either the upper frame or the lower frame of the carrier, and supporting the rest sides of each liquid crystal cell.

Also, to achieve the other object, an image projection system using a structure of projection lenses in accordance with the present invention uses at least one light source, dichroic mirrors separating light emitted from the light source into R, G, and B colors, liquid crystal cells selectively turning on/off light outputted from the dichroic mirrors, and the structure of the projection lenses moving R, G, and B projection lenses in a predetermined axial direction. The structure of the projection lenses comprises: frames having piercing grooves pierced on both sides; more than one shaft mounted on upper and lower sides of the frames; supporting plates installed for the R, G, and B projection lenses, respectively, and having inserting grooves pierced on the left and the right to insert the shafts into upper ends and lower ends; the R, G, and B projection lenses mounted on back sides of each supporting plate for an incident direction of light; many elastic members inserted into the shafts, disposed between inserting grooves of neighboring supporting plates among the supporting plates, and supporting each supporting plate; and more than one fine adjuster inserted/tied to each piercing groove of the frames, and compressing sides of the supporting plates.

In addition, to achieve the other object, another embodiment of an image projection system using a structure of projection lenses in accordance with the present invention uses at least one light source, dichroic mirrors separating light emitted from the light source into R. Q and B colors, liquid crystal cells selectively turning on/off light outputted from the dichroic mirrors, and the structure of the projection lenses moving R, G, and B projection lenses in a predetermined axial direction. The structure of the projection lenses comprises: a carrier, the carrier having at least one frame of an upper frame and a lower frame, the upper frame and the lower frame configured in bar shape; the R, G, and B projection lenses, the R, G and B projection lenses respectively disposed on back sides of each liquid crystal cells for an incident direction of light, and the R, G, and B projection lens tied to at least one frame of the carrier; and a rail, the rail formed in horizontal direction on a side where the R, G, and B projection lenses are tied to said frame of the carrier.

To accomplish another object, the present invention presents a structure of a liquid crystal cell and a projection lens which rotating and moving at a predetermined axis direction, said structure comprising, a plurality of holders which having a liquid crystal cell attached, a window through which light is passing formed at a center, wherein said light being incident on an effective screen of said liquid crystal cell, and a predetermined sized alignment hole near a corner, a carrier which being inserted into each alignment hole of each holder, and having alignment pins with smaller diameter than that of said alignment holes, and including an upper and lower frames in bar shape; glue adhering said a plurality of holders to said carrier; and a projection lens which being placed in opposition to a place to which said liquid crystal cell of said carrier adhering.

The present invention will now be described in detail with reference to exemplary preferred embodiments as illustrated in the accompanying drawings.

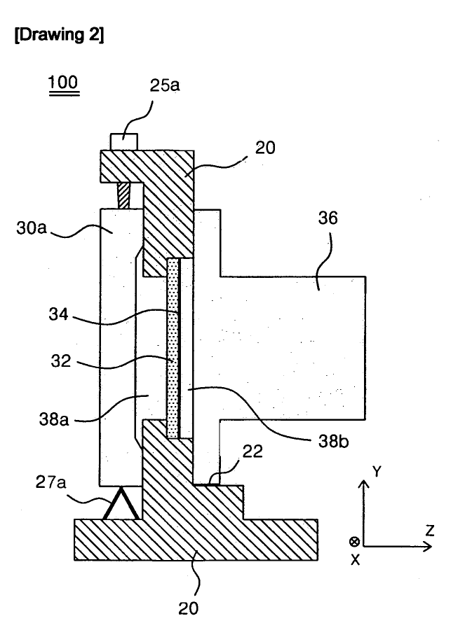

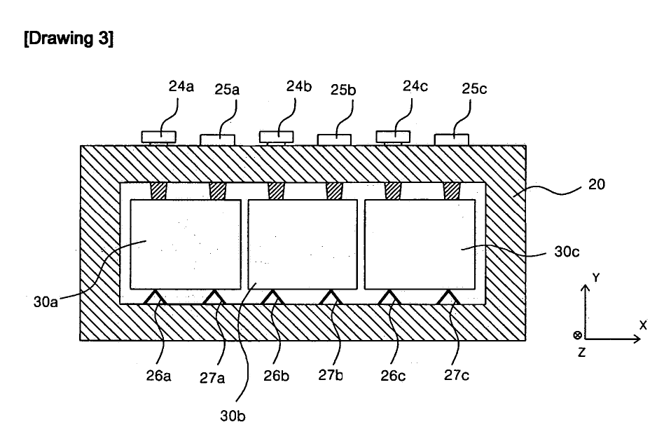

FIG. 2 is a sectional view in side direction of a structure of liquid crystal cells and projection lenses in accordance with the present invention, and FIG. 3 is a front view for a light direction of a structure of liquid crystal cells and projection lenses in accordance with the present invention. In each liquid crystal cell(30a,30b,30c) for R, G, and B colors illustrated in FIG. 2 and FIG. 3, light separated into the colors through dichroic mirrors is incident. Also, in FIG. 3, it is possible to configure each liquid crystal cell with R, G, and B or B, R, and R from the left side. Hereinafter, the R, G, and B colors will be described for convenience' sake.

Referring to FIG. 2 and FIG. 3, a structure of liquid crystal cells and projection lenses in accordance with the present invention will be described as follows.

In a structure(100) of liquid crystal cells and projection lenses, the liquid crystal cells(30a,30b,30c), substrates(32), and the projection lenses(36) are sequentially disposed for an incident direction of light, and each of them is fixed by a carrier(20).

The carrier(20) comprises bar-shaped upper and lower frames. The upper frame includes a tightening screw and the lower frame includes a support member or elastic member.

In addition, analyzers(34) are attached to one side of the substrates(320 for a direction of light. Both the liquid crystal cells(30a,30b,30c) and the substrates(32) and both the analyzers(34) and the projection lenses(36) are disposed at certain intervals. That is, air gaps(38a,38b) are put between the liquid crystal cells and the substrates and between the analyzers and the projection lenses. Of course, the substrates(32), the analyzers(34), and the projection lenses(36) are installed for each of the R, G, and B liquid crystal cells(30a,30b,30c). Each component will now be described in detail.

Like shown in FIG. 3, the liquid crystal cells(30a,30b,30c) are sequentially arranged by being covered with a carrier(20). Lower sides of each liquid crystal cell are supported by two springs(26a-26c, 27a-27c), and upper sides thereof are compressed by two screws(24a-24c, 25a-25c). Thus, piercing grooves pierced to insert the screws(24a-24c, 25a-25c) are installed in regions where the liquid crystal cells(30a,30b,30c) are disposed in lower parts of an upper frame of the carrier(20). On this occasion, it is available to have more than two springs corresponding to the screws.

Meanwhile, it is desirable to locate each screw(24a-24c, 25a-25c) and the corresponding springs(26a-26c, 27a-27c) on the same extension in vertical direction. Therefore, it can vertically move each of the liquid crystal cells(Y-axis direction) as easily rotating Oz, depending on tightening degrees of left/right screws. More specifically, in case of the R liquid crystal cell(30a), as the tightening degrees of the left/right screws(24a,25a) get weaker, the R liquid crystal cell(30a) goes up by an elastic force of the springs(26a,27a). On the contrary, as the tightening degrees get stronger, the R liquid crystal cell(30a) goes down, thereby easily controlling a position of the Y-axis direction of the R liquid crystal cell. Moreover, if each screw(24a,25a) is differently tightened, the R liquid crystal cell(30a) relatively slopes toward a more tightened screw. Thus, it can easily control the rotation of θ_{Z}.

On the other hand, unlike FIG. 2 and FIG. 3, it is possible for the springs(26a-26c, 27a-27c) to support upper sides of each liquid crystal cell(30a,30b,30c) and for the screws(24a-24c, 25a-25c) to compress lower sides of each liquid crystal cell.

Moreover, other support members can be used, such as a screw, pin structure etc. instead of the springs(26a-26c, 27a-27c).

Each of the substrates(32) is made of glass or sapphire substrates. Like shown in FIG. 2, the substrates(32) are mounted on the carrier(20), opposite to each liquid crystal cell(30a,30b,30c). At this moment, perimeter regions of the substrates are contacted with a portion of the carrier.

Also, like shown above, the analyzers(34) are attached to front sides or back sides of the substrates, that is, one side of each substrate(32), for a direction of light.

Lower sides of each projection lens(36) are tied to the carrier(20), and a rail(22) is formed on a side of the carrier contacted with the lower sides of the projection lenses. Accordingly, each projection lens(36) can slide along the rail(22), thereby easily controlling a position of an X-axis direction. After controlling each projection lens(36) in the X-axis direction, fix the lenses with adhesives, screws or other coupling units. And, it is possible to control magnifications of the projection lenses by turning each projection lens(36).

In the meantime, unlike FIG. 2, it is available for the carrier(20) to tie upper sides of each projection lens(36) and to form the rail(22) on the side of the carrier contacted with the upper sides of each projection lens. Also, the carrier can simultaneously tie the upper sides and the lower sides together of each projection lens.

Like shown in FIG. 1, a system(3-liquid crystal 3-projection lens system, image projection system) using 3 liquid crystal cells for 3 R, G, and B colors and 3 projection lenses corresponding to each liquid crystal cell generates entire color images by synthesizing each R, G, and B image. At this time, in order to adjust focuses of the R, G, and B images projected from each projection lens on a screen, X-axis positions and Y-axis positions of each liquid crystal cell and each projection lens of the structure(100) of the liquid crystal cells and the projection lenses as well as Oz rotations should be controlled. Specifically, the Y-axis positions of each liquid crystal cell(30a,30b,30c) and the θ_{Z} rotations should be controlled, as controlling the X-axis positions of each projection lens(36).

First, the Y-axis positions of each liquid crystal cell(30a,30b,30c) and the θ_{Z} rotations are controlled by the tightening degrees of the screws. For example, in case of the R liquid crystal cell(30a), it can control the Y-axis position of the R liquid crystal cell(30a) by an elastic force of the springs(26a,27a) by strongly or weakly tightening the left/right screws(24a,25a). Furthermore, if the left/right screws(24a,25a) are differently tightened, the R liquid crystal cell(30a) slopes toward a more tightened screw. Thus, it is possible to control the θ_{Z} rotations. The G liquid crystal cell(30b) and the B liquid crystal cell(30c) are the same as the R liquid crystal cell(30a), thereby being omitted.

Next, the X-axis positions of the projection lenses(36) can be controlled by sliding the projection lenses(36) in X-axis direction along the rail(22) of the carrier(20). After controlling the X-axis positions of the projection lenses(36), fix the lenses with adhesives, screws or other coupling units.

On this occasion, the X-axis positions and the Y-axis positions are controlled according to a desired projection distance. If the projection distance changes, the X-axis positions should be adjusted accordingly, but the Y-axis positions and the θ_{Z} rotations can be controlled or not, under certain circumstances.

Thus, in a structure of the liquid crystal cells and the projection lenses, each projection lens and each liquid crystal cell are controlled in order to synthesize R, G, and B colors for predetermined projection distance. And, it can control the projection distance by moving the structure(100) of the liquid crystal cells and the projection lenses for the screen.

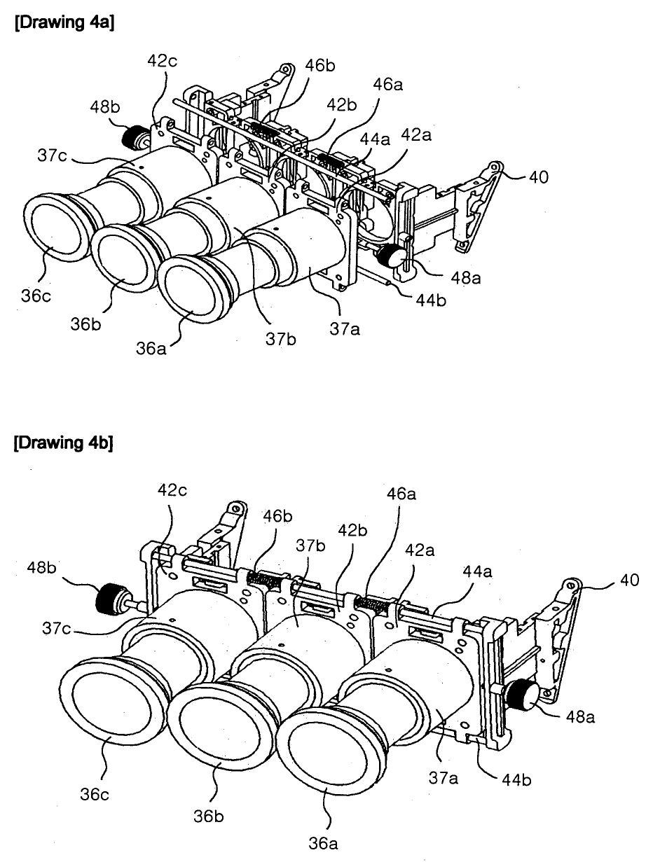

FIG. 4 is a perspective view of a structure of projection lenses in accordance with the present invention, and FIG. 4a is a disassembling perspective view of a structure of projection lenses, then FIG. 4a an assembling perspective view of a structure of projection lenses. The structure of the projection lenses illustrated in FIG. 4a and FIG. 4b corresponds to a back end of a carrier(20) where projection lenses(36) are mounted, based on a direction of light, and more precisely controls X-axis positions of each projection lens(36a,36b,36c). Each projection lens of FIG. 4a and FIG. 4b is disposed in order of R, G, and B or B, G, and R from the right, and hereinafter, the projection lenses will be disposed in the order of R, G, and B from the right in order to be accorded with the description of FIG. 2.

In the structure of the projection lenses, shafts(44a,44b) are mounted on front upper/lower sides of a frame(40), and supporting plates(42a,42b,42c) of each projection lens(36a,36b,36c) are tied to the upper and lower shafts. Inserting grooves pierced on the left and the right are formed on upper ends and lower ends of each supporting plate(42a,42b,42c) so as to be inserted into the shafts(44a,44b). And, external diameter pipes(37a,37b,37c) of the projection lens are mounted in front direction(which light is emitted) of each supporting plate, respectively. The R, G, and B projection lenses(36a,36b,36c) are mounted on each of the external diameter pipes.

Meanwhile, two springs(46a,46b) are inserted into the upper/lower shafts(44a,44b), and more specifically, the springs are installed between the inserting grooves of each supporting plate(42a,42b,42c). Furthermore, fine adjusting screws(48a,48b) for finely adjusting X-axis positions of the supporting plates(42a,42c) among the supporting plates are mounted on both sides of the frame(40). So, piercing grooves pierced on the left and the right are formed on both sides of the frame.

A process of controlling the X-axis positions of the projection lenses(36a,36b,36c) by using the lens structure in accordance with the present invention will be described as follows.

First, after inserting each supporting plate(42a,42b,42c) of the projection lenses into the shafts(44a,44b), fix the supporting plate(42b) of the G projection lens disposed in the middle into the frame. Next, if the fine adjusting screws(48a,48b) are tightened, the fine adjusting screws push a right side of the supporting plate(42a) and a left side of the supporting plate(42c) of the R projection lens, which are disposed on both sides. Thus, both the supporting plates(42a,42c) move in a direction, being closely adhered to the supporting plate(42b) of the G projection lens. Also, if the fine adjusting screws(48a,48b) are loosened, the supporting plate(42a) of the R projection lens and the supporting plate(42c) of the B projection lens are pushed by the springs(46a,46b), respectively, thereby being separated from the supporting plate(42b) of the G projection lens. In this way, it is possible to control the X-axis positions of the supporting plate of the B projection lens and the supporting plate of the R projection lens by using the left/right fine adjusting screws(48a,48b), and to fix the plates into the frame(40).

Like mentioned above, it can control magnifications of each projection lens(36a, 36b, 36c) by turning the projection lenses, respectively.

The structure of the projection lenses illustrated in FIG. 4a and FIG. 4b can be applied to the structure(100) of the liquid crystal cells and the projection lenses capable of controlling the Y-axis positions of the liquid crystal cells and the θ_{Z} rotations, like shown in FIG. 2 and FIG. 3. Moreover, it can be applied to a structure of fixed liquid crystal cells and projection lenses.

In an embodiment of FIG. 2 to FIG. 4, it shows structure in that the liquid crystal cells move parallel to the Y-axis direction and rotate on the θ_{Z}-axis and the projection lens can move parallel to the X-axis direction. The following embodiment has the same effect by moving and/or rotating only the liquid crystal cell.

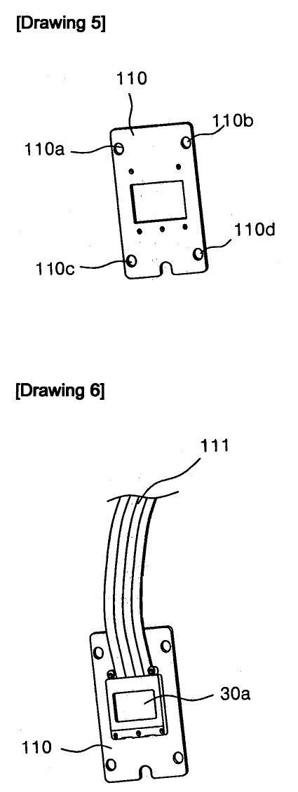

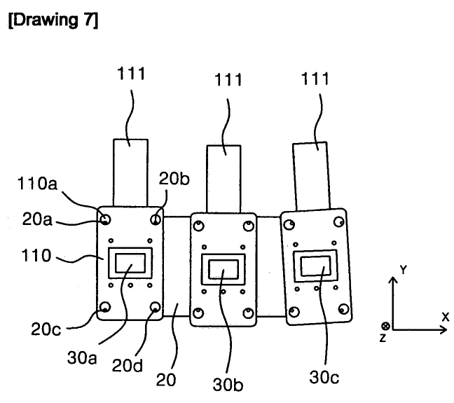

FIG. 5 shows the holder for liquid crystal cell according to the embodiment of the present invention. FIG. 6 shows the holder with the liquid crystal cell on according to the embodiment of the present invention.

The window is formed at the center of the holder (110). The light incident on the effective screen of the liquid crystal cell is passing through the window. The alignment holes (110a, 110b, 110c, 110d) are formed at the four corners each. The liquid crystal cell (30a) is inserted into the small hole around the window of the holder, or glued to the area around the window. The liquid crystal cell (30a) is connected to outer control circuit by the flexible cable (111) as shown in FIG. 6.

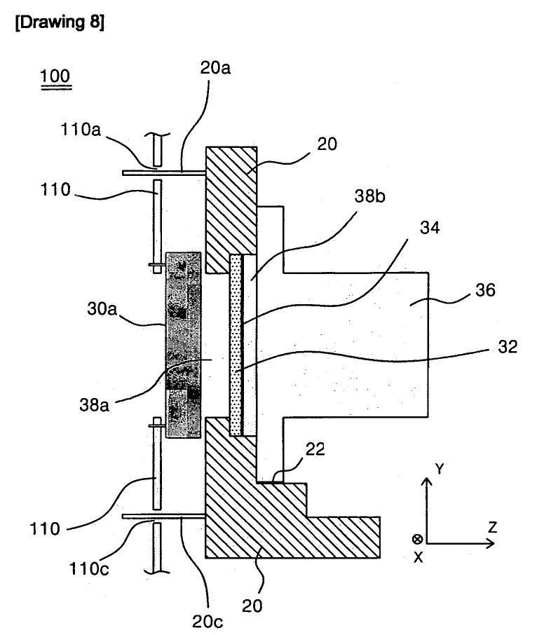

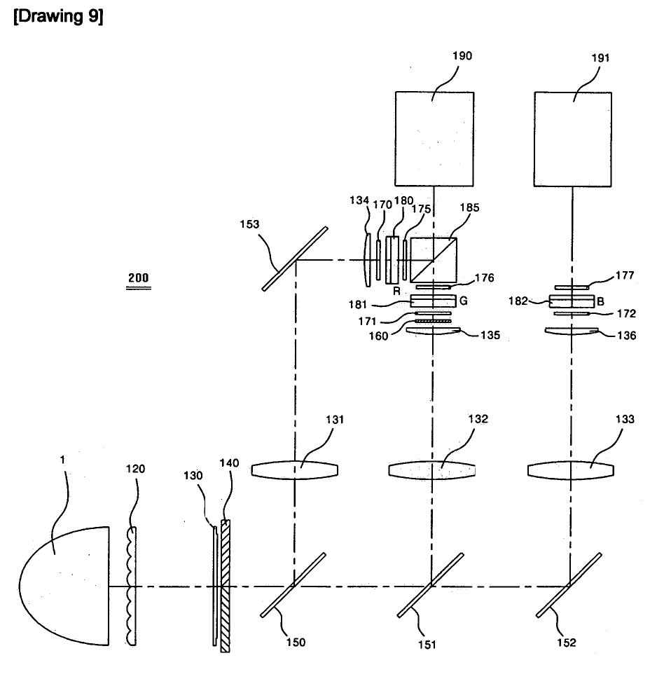

FIG. 7 illustrates the alignment of the liquid crystal on the carrier according to the embodiment of the present invention. FIG. 8 is a perspective view showing the alignment of the liquid crystal on the carrier according to the embodiment of the present invention.

At the upper and lower part of the carrier (20), the each alignment pin (20a, 20b, 20c, 20d) is inserted into each alignment hole (110a, 110b, 110c, 110d) of the holder (110). The diameter of each alignment pin (20a, 20b, 20c, 20d) is formed shorter than that of alignment hole (110a, 110b, 110c, 110d) to have some space, and the liquid crystal cell can move parallel and rotate. The explanation of other reference numbers can be cited in that of FIG. 2. In FIG. 8, because the liquid crystal cell can move and rotate on the transverse axis the projection lens can be made in place. And the projection lens can be modified into the structure having shafts presented in FIG. 4a to FIG. 4d.

It is shown in FIG. 7 that the liquid crystal cell 30a is moved parallel to the +y axis direction. This can be identified by that the alignment pins (20a, 20b, 20c, 20d) are touched with the lower parts of the alignment holes (110a, 110b, 110c, 110d).

It is shown in FIG. 7 that the liquid crystal cell 30b is moved parallel to the −y axis direction. This can be identified by that the alignment pins (20a, 20b, 20c, 20d) are touched with the upper parts of the alignment holes (110a, 110b, 110c, 110d).

It is shown in FIG. 7 that the liquid crystal cell 30c is rotated on the −θ_{Z} axis. This can be identified by that the alignment pins (20a, 20b, 20c, 20d) are touched with the alignment holes (110a, 110b, 110c, 110d). In analogous way, the each liquid crystal cell can move parallel to the x-axis direction and/or y-axis direction.

It is shown in FIG. 8 that the liquid crystal cell (30a) and the holder (110) are joined together by the pins keeping small space between them as an embodiment. But it is desirable that the liquid crystal cell (30a) and the holder (110) are joined together without any space between them. As described above, it is possible to glue the liquid crystal cell (30a) and the holder (110) together.

The process for the alignment is explained below by using the liquid crystal cell in FIG. 5 to FIG. 8. The first step is joining the liquid crystal cell is joined to the holder (110). The second step is putting the joined liquid crystal cells (30a, 30b, 30c) on the alignment pins (20a,20b,20c,20d). The third step is putting the holder (110) in place by the use of the alignment equipment and adjusting the alignment of the each liquid crystal cell (30a, 30b, 30c) by moving the holder minutely. The fourth step is fixing the each aligned liquid crystal cell by applying the UV glue on the minute space between the alignment pin (20a, 20b, 20c, 20d) and the holder (110), especially, the alignment holes (110a, 110b, 110c, 110d). The last step is beaming the U light on the UV glue to harden it. After the last step, the process is finished for aligning the liquid crystal cell at the designed place.

The present invention can be easily applied to the liquid crystal projection system (hereinafter denoted as ‘composite liquid crystal projection system’) as another embodiment, which projects by use of one compound lens and two projection lenses in FIG. 9, in addition to the one plate mode liquid crystal projection system which uses one compound lens and the three plate mode liquid crystal projection system which includes three projection lenses.

The composite liquid crystal projection system (200) comprises a light source (1) emitting light in front, a fly-eye lens (120, 130) making intensity of light emitted from the light source uniform, condensing lens (131 to 136) which condenses light incident, Polarization conversion system (PCS, 140) which makes the polarization of light in stable state, a dichroic mirror (150, 151) which reflects specific color of light and projects the rest color of light among lights incident, a reflector (152, 153) which reflects light incident in a specific direction, a retarder (160) which changes the direction of polarization of light incident, a polarizer (170 to 172) which makes light with a specific polarization direction passing through among light incident, an analyzer (175 to 177), liquid crystal panels (180 to 182) which produce images to light incident of a specific color, polarizing beam splitter (PBS) (185) which compounds images of light incident of each color and projection lenses (190, 191) which magnifies and projects image incident on the screen. The lens system of the composite liquid crystal projection system (200) in FIG. 9 might be seen different from that of the three-plates liquid crystal projection system in FIG. 1. But its difference has been known in relevant area and various modification is possible. For example, the fly-eye lenses (120, 130) can be applied to the liquid crystal projection system of FIG. 1 and instead, integrator can be used.

The composite liquid crystal projection system (200) reflects light emitted from the light source (1) into R, G selectively by use of the dichoric mirrors (150, 151). And it selectively makes light passing through by use of R liquid crystal (180) and G liquid crystal (181) each. R and G images selectively projected are compounded by use of the PBS and is projected on the screen by use of the projection lens (191). The rest B light is passing through the reflector (152) and projected on the B liquid crystal (182). The selectively projection images by the B liquid crystal is projected on the screen by use of the projection lens (191).

The two colors of light compounded by the PBS (185) can be selected as B/G or R/B instead of R/G, and the remaining one color of light is projected on the screen through the projection lens (191) without passing through PBS (185).

### EFFECT OF THE INVENTION

As stated so far, a structure of liquid crystal cells and projection lenses in accordance with the present invention and an image projection system using the same can easily control the liquid crystal cells and the projection lenses in order to exactly adjust focuses thereof.

In addition, not only it can more precisely control positions of each projection lens by using a structure of the projection lenses for finely adjusting X-axis positions of R, G, and B projection lenses, but the structure of the projection lenses can be applied to both a structure of fixed liquid crystal cells and a structure capable of controlling Y-axis positions of the liquid crystal cells and θ_{Z} rotations.

While this invention has been described in terms of several preferred embodiments, there are alterations, permutations, and equivalents which fall within the scope of this invention.

1. A structure of liquid crystal cells and projection lenses movable in a predetermined axial direction with rotations, said structure comprising:
a carrier having an upper frame and a lower frame configured in bar shape;
R, G, and B liquid crystal cells disposed between the upper frame and the lower frame of the carrier;
analyzers installed for the R, G, and B liquid crystal cells, respectively, and disposed on back sides of each liquid crystal cell at certain intervals;
projection lenses installed for the R, G, and B liquid crystal cells, respectively, disposed on back sides of each analyzer at certain intervals for an incident direction of light, and tied to at least either the upper frame or the lower frame of the carrier; and
a rail formed in horizontal direction on a side where the projection lenses are tied to either the upper frame or the lower frame of the carrier; wherein
each liquid crystal cell, comprising:
at least two tightening members compressing one side of either an upper side or a lower side of each liquid crystal cell by being tied and tightened in a piercing groove formed on one of either the upper frame or the lower frame of the carrier; and
at least two support members which being mounted between the other side of either the upper side and the lower side of each liquid crystal cell and the other one of either the upper frame or the lower frame of the carrier, and supporting the rest sides of each liquid crystal cell.

2. The structure of claim 1, wherein said support member including an elastic member.

3. The structure of claim 1, wherein each tightening member and each elastic member are disposed on the same extension in vertical direction.

4. The structure of claim 1, wherein the structure of the liquid crystal cells and the projection lenses further including substrates attached to one side of each analyzer, opposite to an incident direction of light.

5. The structure of claim 4, wherein the substrates being sapphire substrates.

6. A structure of projection lenses capable of moving each projection lens in a predetermined axial direction for R, G, and B projection lenses on which light selectively turned on/off by liquid crystal cells is incident by being separated into R, G, and B colors, comprising:
frames having piercing grooves pierced on both sides;
more than one shaft mounted on upper and lower sides of the frames;
supporting plates installed for the R, G, and B projection lenses, respectively, and having inserting grooves pierced on the left and the right to insert the shafts into upper ends and lower ends;
the R, G, and B projection lenses mounted on back sides of each supporting plate for an incident direction of light;
many elastic members inserted into the shafts, disposed between inserting grooves of neighboring supporting plates among the supporting plates, and supporting each supporting plate; and
more than one fine adjuster inserted/tied to each piercing groove of the frames, and compressing sides of the supporting plates.

7. The structure of claim 6, wherein each supporting plate further includes many piercing grooves pierced on front and rear sides in order to insert fixing members for fixing each supporting plate into the frames.

8. In an image projection system using at least one light source, dichroic mirrors separating light emitted from the light source into R, G, B colors, liquid crystal cells selectively turning on/off light outputted from the dichroic mirrors and movable in a predetermined axial direction with rotations, and a structure of the liquid crystal cells and projection lenses, the structure of the liquid crystal cells and the projection lenses comprising:
a carrier having an upper frame and a lower frame configured in bar shape;
R, G, and B liquid crystal cells disposed between the upper frame and the lower frame of the carrier;
analyzers installed for the R, G, and B liquid crystal cells, respectively, and disposed on back sides of each liquid crystal cell at certain intervals;
projection lenses installed for the R, G, and B liquid crystal cells, respectively, disposed on back sides of each analyzer at certain intervals for an incident direction of light, and tied to at least either the upper frame or the lower frame of the carrier; and
a rail formed in horizontal direction on a side where the projection lenses are tied to either the upper frame or the lower frame of the carrier; wherein
each liquid crystal cell, comprising:
at least two tightening members compressing one side of either an upper side or a lower side of each liquid crystal cell by being tied and tightened in a piercing groove formed on one of either the upper frame or the lower frame of the carrier; and
at least two elastic members which being mounted between the other side of either an upper side and a lower side of each liquid crystal cell and the other one of either an upper frame or a lower frame of the carrier, and supporting rest sides of each liquid crystal cell.

9. In an image projection system uses at least one light source, dichroic mirrors separating light emitted from the light source into R, G, and B colors, liquid crystal cells selectively turning on/off light outputted from the dichroic mirrors, and a structure of projection lenses moving R, G, and B projection lenses in a predetermined axial direction, the structure of the projection lenses comprising:
frames having piercing grooves pierced on both sides;
more than one shaft mounted on upper and lower sides of the frames;
supporting plates installed for the R, G, and B projection lenses, respectively, and having inserting grooves pierced on the left and the right to insert the shafts into upper ends and lower ends;
the R, G, and B projection lenses mounted on back sides of each supporting plate for an incident direction of light;
many elastic members inserted into the shafts, disposed between inserting grooves of neighboring supporting plates among the supporting plates, and supporting each supporting plate; and
more than one fine adjuster inserted/tied to each piercing groove of the frames, and compressing sides of the supporting plates.

10. A structure of projection lenses capable of moving each projection lens in a predetermined axial direction for R, G, and B projection lenses on which light selectively turned on/off by liquid crystal cells is incident by being separated into R, G, and B colors, comprising:
a carrier, said carrier having at least one frame of an upper frame and a lower frame, said upper frame and said lower frame configured in bar shape;
R, G, and B liquid crystal cells which being placed in front of said carrier for an incident direction of light,
said R, G, and B projection lenses, said R, G, and B projection lenses respectively disposed on back sides of each liquid crystal cells for an incident direction of light, and said R, G, and B projection lens tied to at least one frame of said carrier; and
a rail, which having a side on which said projection lenses move in an light incident direction and an vertical direction to said light incident.

11. A projection system comprising said projection lens structure of claim 10.

12. A structure of a liquid crystal cell and a projection lens which rotating and moving at a predetermined axis direction,
said structure comprising,
a plurality of holders which having a liquid crystal cell attached, a window through which light is passing formed at a center, wherein said light being incident on an effective screen of said liquid crystal cell, and a predetermined sized alignment hole near a corner, a carrier which being inserted into each alignment hole of each holder, and having alignment pins with smaller diameter than that of said alignment holes, and including an upper and lower frames in bar shape;
glue adhering said a plurality of holders to said carrier; and
a projection lens which being placed in opposition to a place to which said liquid crystal cell of said carrier adhering.

13. The structure of a liquid crystal cell and a projection lens of claim 12, wherein said glue being hardening material.

14. An image projection system comprising structure of a liquid crystal cell and a projection lens of claim 12,

15. The image projection system of claim 14, wherein said image projection system comprising
a polarized beam splitter which compounding R beam & G beam, B beam & G beam, or R beam and B beam;
a first projection lens which projecting on a screen said compounded R beam & G beam, B beam & G beam, or R beam and B beam; and
a second projection lens which directly projecting one remaining beam which passing through liquid crystal on said screen.

16. An image projection system comprising structure of a liquid crystal cell and a projection lens of claim 13, 17. The image projection system of claim 16, wherein said image projection system comprising
a polarized beam splitter which compounding R beam & G beam, B beam & G beam, or R beam and B beam;
a first projection lens which projecting on a screen said compounded R beam & G beam, B beam & G beam, or R beam and B beam; and
a second projection lens which directly projecting one remaining beam which passing through liquid crystal on said screen.
